(19) United States
(12) Patent Application Publication
(10) Pub. No.: US 2026/0304418 A1
(43) Pub. Date: Oct. 1, 2026

(54) FLEXIBLE SCHEDULING CONSIDERING PACKET DELAY BUDGET

(71) Applicant: QUALCOMM Incorporated, San Diego, CA (US)

(72) Inventors: Zhichao ZHOU, Beijing (CN); Seyedkianoush HOSSEINI, San Diego, CA (US); Ahmed ELSHAFIE, San Diego, CA (US); Huilin XU, Temecula, CA (US); Prashanth Haridas HANDE, San Diego, CA (US); Diana MAAMARI, San Diego, CA (US)

(21) Appl. No.: 19/100,895

(22) PCT Filed: Aug. 22, 2022
(86) PCT No.: PCT/CN2022/113841

§ 371 Date: Feb. 3, 2025

(51) Int. Cl. H04W 72/1268; H04W 28/02; H04W 72/231

(52) U.S. Cl. CPC H04W 72/1268; H04W 28/0236; H04W 28/0278; H04W 72/231

(57) ABSTRACT

Certain aspects of the present disclosure provide a method for wireless communications by a user equipment (UE) generally including determining a packet delay budget (PDB) for traffic to or from a user equipment (UE) and receiving signaling, from a network entity, scheduling the traffic in accordance with one or more parameters determined based on the PDB.

### BACKGROUND

### Field of the Disclosure

Aspects of the present disclosure relate to wireless communications, and more particularly, to techniques for scheduling traffic considering a packet delay budget (PDB).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes determining a packet delay budget (PDB) for traffic to or from a UE; and receiving signaling, from a network entity, scheduling the traffic in accordance with one or more parameters determined based on the PDB.

Another aspect provides a method for wireless communications by a network entity. The method includes determining one or more parameters based on a PDB for traffic to or from a UE; and transmitting signaling scheduling the traffic with the one or more parameters determined based on the PDB.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts example packet delay budgets (PDBs) for different types of traffic.

FIG. 6 depicts an example of block error rate (BLER) for transmissions.

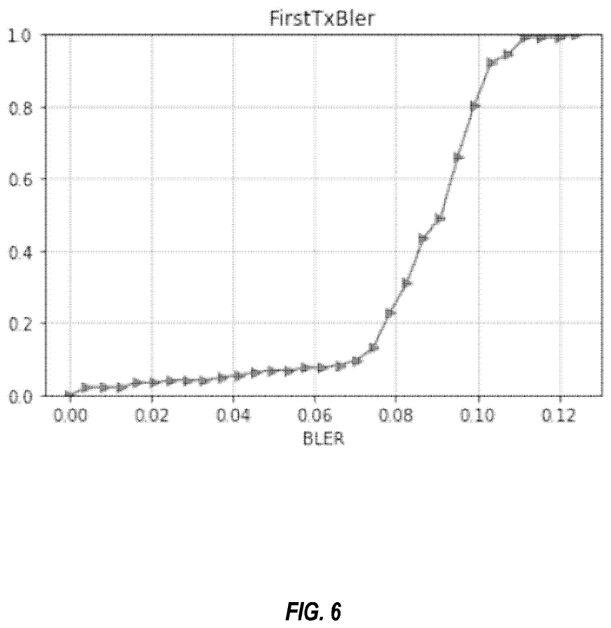

FIG. 7 depicts an example call flow diagram for PDB based scheduling, in accordance with aspects of the present disclosure.

FIG. 8 depicts a method for wireless communications.

FIG. 9 depicts a method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for scheduling techniques that consider packet delay budgets (PDBs).

5G new radio (NR) provides a high-speed, low-latency and high-reliability wireless connectivity which can enable a wide variety of applications. One approach to increase reliability of transmissions is through mechanisms that utilize retransmissions. For example, a hybrid automatic repeat request (HARQ) mechanism automatically retransmits packets if they are not acknowledged. Each HARQ process can have one packet pending acknowledgment. While the HARQ process is less than optimal from a resource utilization standpoint, retransmissions greatly increase the reliability.

Some types of latency-sensitive traffic, however, may not be able to use retransmission mechanisms. For example, advanced multimedia applications, such as immersive extended reality (XR) multimedia services may require high data rate and low latency to help traffic meet its packet delay budget (PDB), which generally refers to an upper bound for the delay of the data packets from an origination point to a termination point.

For XR flows, there may be no opportunity for retransmissions, due to stringent PDB requirements. This may present a challenge to meet both high reliability (e.g., >99%) and very stringent latency requirement with the current traffic scheduling techniques. Further, retransmissions that exceed PDB requirements result in a waste of power and wireless resources.

Various cases may not be suitable to use retransmission to improve for reliability of XR traffic. For example, a first case is when there is not enough time left for a user equipment (UE) or network entity (e.g., a gNB) to merge an initial transmission and a first retransmission (reTx) of a packet (let alone multiple reTx), due to PDB requirements. A second case is when there is not enough time left for a UE to blind decode downlink control information (DCI) scheduling a reTx, as blind decoding is time consuming. A third case is when a reTx is successfully received at a modem, but exceeds the PDB in an application layer for a specific PDU set.

Aspects of the present disclosure, however, provide scheduling mechanisms that consider PDB requirements for latency-sensitive traffic. By considering the PDB requirements, flexible scheduling can be conducted and a tradeoff may be achieved between various considerations, such as reliability, PDB, and Tx power. The tradeoff may be achieved by adjusting various parameters based on PDB, such as modulation and coding scheme (MCS), transport block (TB) size, and occupied resources for latency-sensitive traffic, such as XR traffic.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

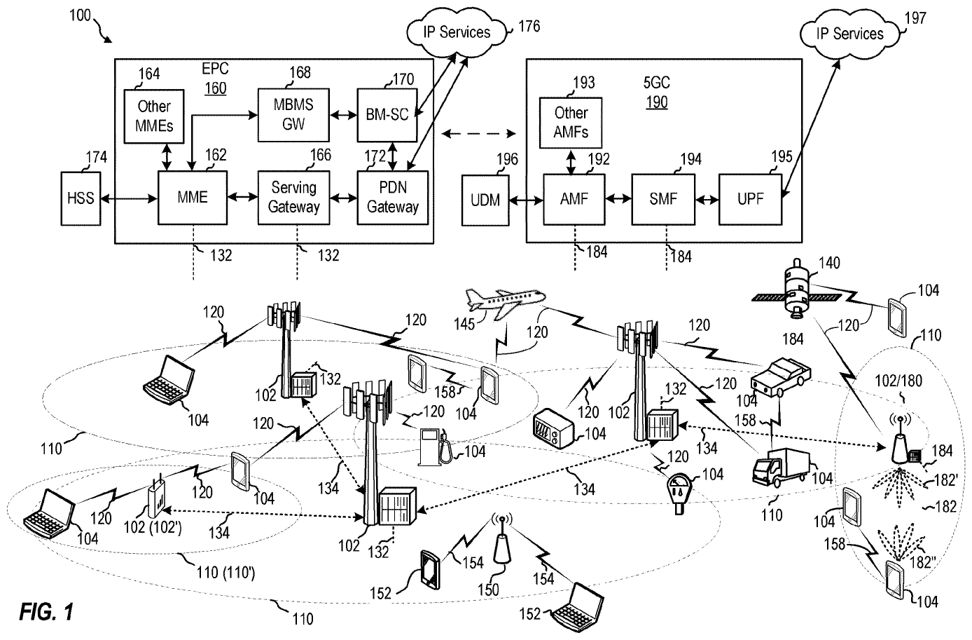

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

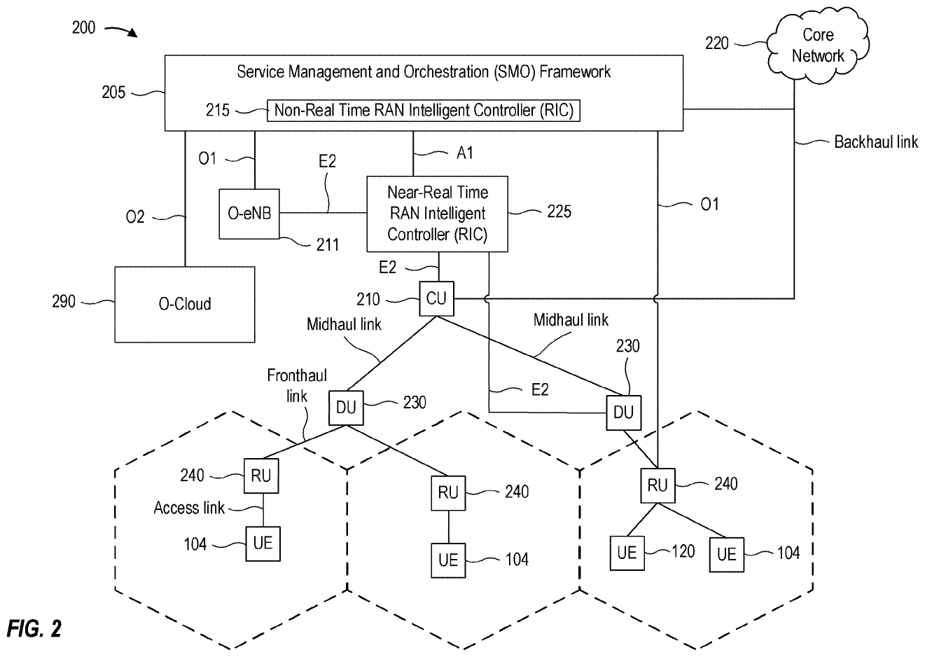

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

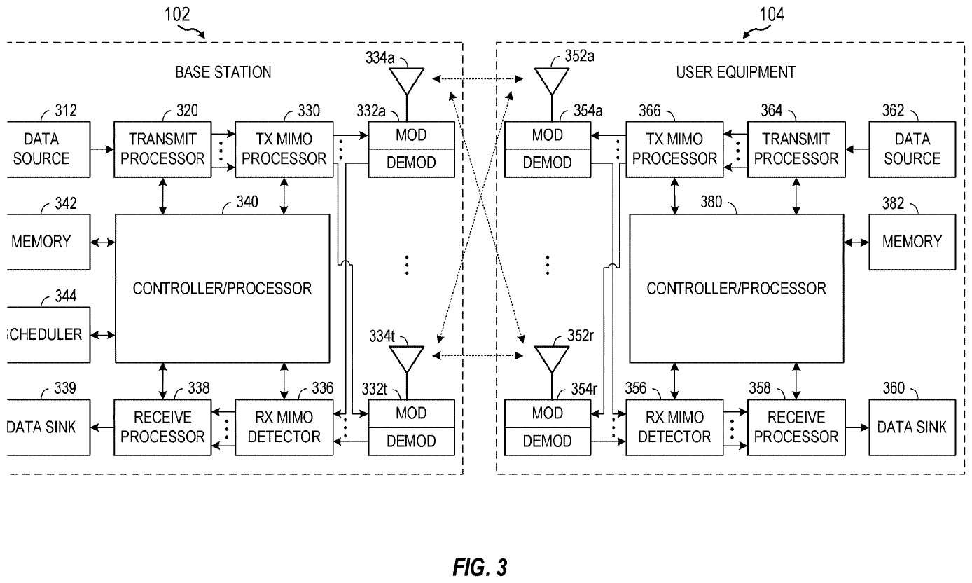

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

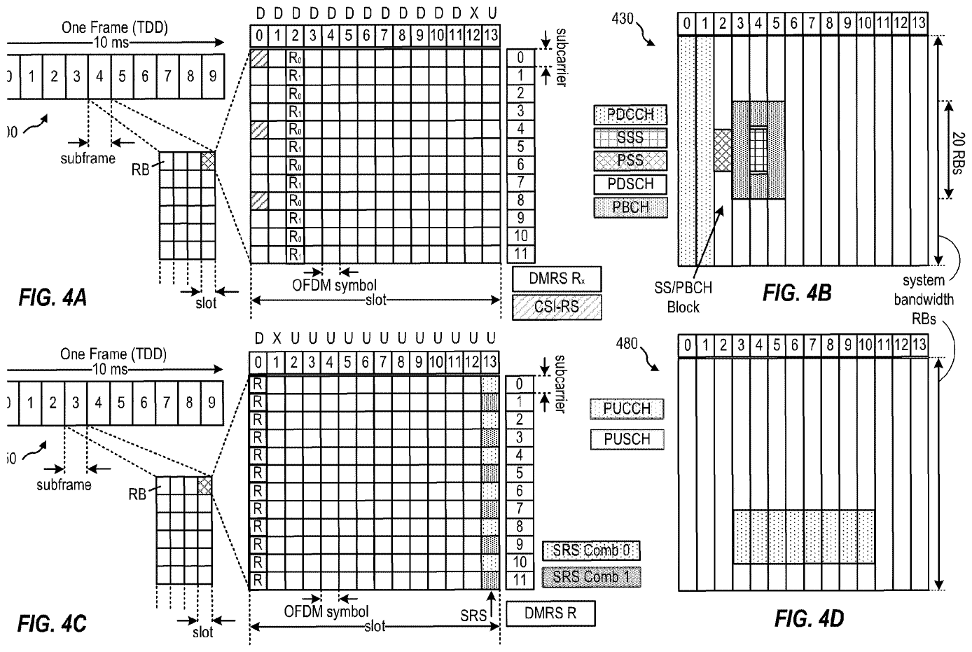

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of XR Traffic Delivery

5G new radio (NR) provides a high-speed, low-latency and high-reliability wireless connectivity which can enable immersive virtual reality (VR), augmented reality (AR) and extended reality (XR) multimedia and cloud computing services. XR/multimedia data services may involve various user interface (UI) devices, such as AR Glasses and VR Head-Mounted Displays (HMDs) used in Cloud-based Gaming and Cloud-based artificial intelligence (AI). These advanced multimedia applications may have strict system requirements. Requirements include high data rate and low latency to better allow a targeted 99% of XR traffic to be delivered within a packet delay budget (PDB) (e.g., 10 ms), and low power consumption to better save power on multimedia devices.

XR-related traffic is typically quasi-periodic. For downlink XR streams, frame per second (Fps) rates of 30 Fps, 60 Fps, 90 Fps and even 120 Fps are expected to be supported. For uplink XR-related traffic, they are often frequent transmissions with small packets. For example, uplink head pose traffic may require Tx frequency of 96 Hz. Periodic traffic of the application layer, typically arrives at the modem with jitter, which generally refers to a difference in time between the packet actual arrival time and its expected arrival time. In some cases, arrival time may be subject to random jitter, for example, which may be assumed to follow a truncated Gaussian distribution (e.g., with zero mean, 2 ms STD and range of [−4, 4] ms).

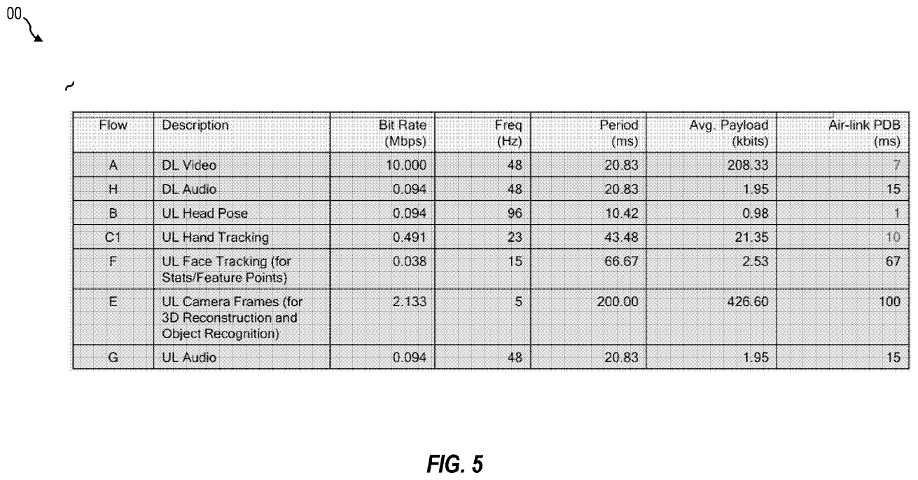

As illustrated in table 500 of FIG. 5, there may be relatively stringent packet delay budget (PDB) for some XR-related traffic flows (e.g., DL XR video and UL Head Pose). Low latency (PDB<=10 ms, PDB=15 ms, PDB=20 ms) and high reliability (99%, 95%) are often important features of XR traffic, from a user experience point of view. Moreover, an XR-related UE (e.g., glasses or headset) is often power limited because of the battery size of XR terminator.

Aspects of the present disclosure provide flexible scheduling techniques that consider PDB requirements. The techniques proposed herein may help enhance Tx reliability, lower reTx, reduce latency of XR, and decrease overall power consumption for an XR terminator.

In conventional traffic scheduling, that does not consider PDB, uplink and downlink (UL/DL) transmission parameters, such as modulation and coding scheme (MCS), resources, and transmit power are based on channel state and data volume (e.g., CSI-RS measurement/report, SRS measurement, and buffer status report (BSR) on the UL. Sufficient reliability of Tx (in terms of block error rate (BLER) can be achieved with retransmission (e.g., HARQ) for traffic without stringent latency requirement.

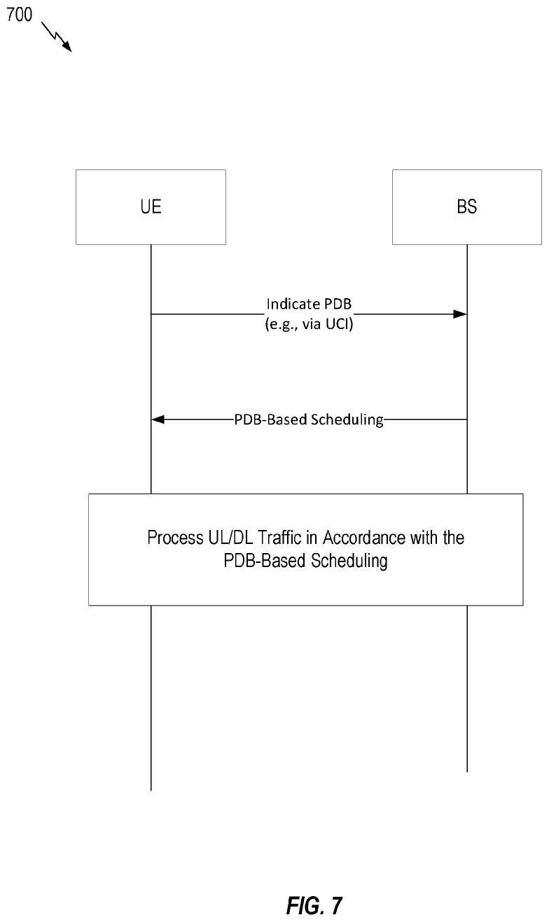

For certain scenarios, such as XR traffic (e.g., with 48 Fps, 10 Mbps @ application layer, TDD mode and slots pattern is DDDSU), reliability of a first transmission may insufficient. For example, as illustrated in FIG. 7, first transmission may have a BLER >9%. In other words, retransmissions may be needed to achieve a 99% reliability requirement for traffic with the current scheduling scheme.

Unfortunately, for some latency-sensitive XR traffic (PDB<10 ms), retransmissions may not be a feasible option. In other words, in these cases there may be no opportunity for retransmission in these XR flows, because of stringent PDB requirements. Thus, it becomes a challenge to meet both high reliability (>99%) and very stringent latency requirement with the current scheduling. In general, retransmission may not be expected for certain types of traffic with stringent PDB requirements (e.g., PDB<10 ms) or very limited reTx may be permitted. Unfortunately, this means high reliability requirements (>99%) may not be met, due to the lack of retransmission.

### Example Flexible Scheduling Considering PDB

Aspects of the present disclosure, however, provide scheduling mechanisms that consider PDB requirements for latency-sensitive traffic. By considering the PDB requirements, flexible scheduling can be conducted and a tradeoff may be achieved between various considerations, such as reliability, PDB, and Tx power. The tradeoff may be achieved by adjusting various parameters based on PDB, such as modulation and coding scheme (MCS), transport block (TB) size, and occupied resources for latency-sensitive traffic, such as XR traffic.

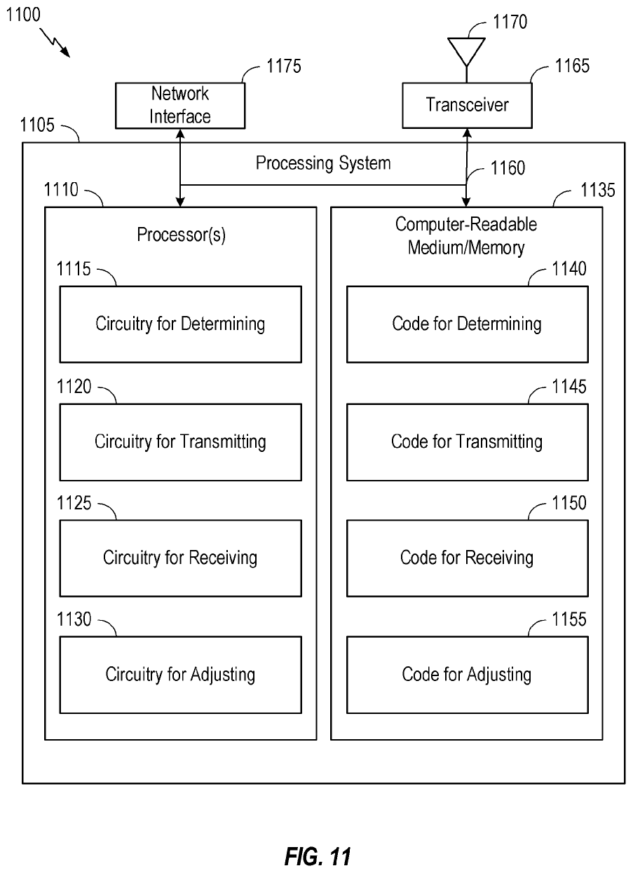

PDB-based scheduling proposed herein may be understood with reference to the call flow diagram 1100 of FIG. 11. As illustrated, a network entity (e.g., a gNB) may determine one or more parameters, based on a packet delay budget (PDB) for traffic to or from a user equipment (UE). The network entity may then transmit signaling (e.g., a DCI) scheduling the traffic with the one or more parameters determined based on the PDB. As illustrated, in some cases, the UE may indicate the PDB to the network entity.

In some cases, a scalingFactor fused to calculate a data rate for XR scheduling may be adjusted, based on a PDB. For example, a gNB may calculate a data rate before scheduling DL/UL traffic as

$$data rate ( in Mbps ) = {10}^{- 6} {\cdot \sum }_{j = 1}^{J} ( {v}_{Layers}^{( j )} \cdot {Q}_{m}^{( j )} \cdot {f}^{( j )} \cdot {R}_{max} \cdot \frac{{N}_{PRB}^{BW ( j ) , μ} \cdot 12}{{T}_{s}^{μ}} \cdot ( 1 - {OH}^{( j )} ) ) .$$

Typically, a relatively coarse granularity of the scalingFactor f is configured by RRC signaling, which may be not suitable for multiple flows of XR with different PDB requirements, and may not be suitable for an XR terminator's capacity.

Aspects of the present disclosure, however, may essentially multiplex the function of data rate of UE and establish a relationship between a PDB requirement of XR traffic and the scalingFactor f. This renewed or adjusted value of f may be configured with RRC signaling. In some cases, a finer granularity of f may be complemented to match the variable PDB requirement of XR flows and the XR UE's capacity.

In some cases, loosened PDB requirements and lower reliability requirements may support a higher scalingFactor, where retransmission may help for reliability. On the other hand, for traffic with stringent PDB requirements, a lower scalingFactor may be configured, because little or no retransmission may be permitted. In some cases, lower MCS, code rate, and/or TB Size (adjusted based on the PDB) may result in less need for retransmissions and higher reliability.

In general, the adjustable scalingFactor may help to configure reasonable data rates for different PDB requirement XR traffic. Using a scalingFactor f (related to PDB requirement) for flexible scheduling in this manner may help to avoid being over-dependent on retransmission to achieve sufficiently high reliability.

According to certain aspects, multiple patterns of scalingFactor may be defined and configured with RRC signaling. The multiple patterns may be suitable for different types of traffic. In some cases, in addition to a conventional scalingFactor, a new feature or pattern of scaling factors, scalingFactor_xr, may be defined for XR traffic considering the characteristics of XR, such as PDB and reliability requirement. The conventional scalingFactor may be used for certain types of traffic (e.g., classical EMBB/sidelink traffic), which can be configured by higher layer (e.g., Layer 3 or L3) signaling.

The new configured scalingFactor_xr pattern may be used for XR traffic and may be configured by L3 signaling. Relative to the conventional scalingFactor, scalingFactor_xr may have finer granularity and may be more flexible for multiple XR flows with different requirements. For example, for very stringent XR flows, smaller scalingFactor_xr is used to limit (cap) the data rate, so lower MCS/Tbsize or more resource, higher power may be used for such flows. For XR traffic with loose (relaxed) latency requirements, a bigger scalingFactor_xr may be used to support a higher data rate, which may permit the use of retransmissions for reliability.

According to certain aspects, information provided via uplink control information (UCI) may assist in flexible scheduling for latency-stringent XR flows. For example, when latency-sensitive XR flows are recognized by a modem at the UE, the UE may notify the required PDB to gNB with UCI (e.g., as shown in FIG. 7).

In such cases, after the gNB receives the required PDB carried by UCI for the following PUSCH, the PDB, as well as other factors including BSR and CSI reports may be considered to determine the MCS, time/frequency resource and Tx power. In this manner, comprehensive factors may be considered by the gNB to determine the MCS and more resource or higher Tx power for the PUSCH Tx. Given the knowledge of the PDB requirements, the use of retransmission may be reduced or avoided, for a given reliability and PDB requirement for latency-stringent XR traffic. In some cases, rather than UCI, the PDB of UL XR traffic may be carried by a medium access control (MAC) control element (CE) to the gNB for flexible scheduling for UL latency-stringent XR flows.

According to certain aspects, a table-based indication with UCI may be used for flexible scheduling for latency-stringent XR flows. For example, XR traffic may have obvious characters, such as PDB, data rate, and periodicity. As such a table may be preconfigured a table according to XR traffic's characteristics, for example, entries with <index, PDB, dataRate> may be defined in the table. In some cases, the table may be stored at the gNB and UE.

For UL traffic, when an XR flow come to the modem of the UE, the UE may select the corresponding index in the preconfigured table according to the signaling. A transmuting UE may then indicate a chosen index, via UCI, to the gNB for flexibly scheduling the uplink XR flow.

According to certain aspects, buffer status report (BSR)-based reporting from a UE to gNB may also be used flexible scheduling for latency-stringent XR flows. For example, traffic with similar quality of service (QoS) requirement logical channels (LCs) may be multiplexed in LC groups (LCGs), and BSR reports may correspond to an LCG. In current BSR reporting, only a LCG ID and data volume index are carried to gNB for scheduling. According to the techniques proposed herein, however, other information, like PDB, may be carried by the BSR accompanying the data volume information signaled to the gNB. The provided PDB of XR flows in an LCG may help the gNB to determine scheduling (e.g., based on MCS, time/frequency resource and Tx power).

In some cases, a pattern-based BSR report may be sent to the gNB for flexible scheduling for latency-stringent XR flows. For example, similar to the table-based indication with UCI for flexible scheduling described above, a table may be preconfigured according to XR traffic's characteristics (e.g., PDB and reliability). In some cases, the BSR may be used to carry the index in the table for specific XR traffic flow to gNB for flexible scheduling.

According to certain aspects, for configured grant (CG)-based UL scheduling, the MCS, TBSize, scheduled resource, and Tx power may be preconfigured for the UE and may be determined by both a CSI report and PDB of traffic carried by L1/L2 signaling.

According to certain aspects, for DL scheduling, as a criteria of whether a decode successfully or not, an expected time threshold may be preconfigured. This threshold may be related to PDB of the XR traffic. When the UE receives downlink packets, the UE may obtain the transmitting time of packets, for example, from a time stamp marked by the gNB.

In such cases, a comparison may be made between the consuming time and the preconfigured threshold, if larger than the threshold. The UE may feedback a specific signaling with UCI to notify the gNB the information. Based on this feedback, the gNB may adjust a scheduling scheme. The specific signaling can be a newly defined cyclic shift, which is different from HARQ-ACK and HARQ-NACK.

According to certain aspects, a specific TB Size computation factor S may be defined for XR traffic, based on an PDB requirement. A current TB Size adjustment factor S′ may be used for some high reliability PDCCH Tx, as:

$${N}_{info} = S \cdot {N}_{RE} \cdot R \cdot {Q}_{m} \cdot υ$$

where the PDCCH TB Size adjustment factor S may be adopted as {0.25, 0.5, 1}.

Aspects of the present disclosure propose extending this concept and complementing the adjustment factor S′ for XR traffic, according to the PDB requirement of the XR traffic. In some cases, a new S table may be defined specific for latency-sensitive traffics (such as XR). In some cases, the granularity of adjustment factor S for XR traffic may be much finer than the current ones for PDCCH. Each component of the defined S may correspond to a cluster of required PDB of XR traffic.

As described above with reference to FIG. 7, the techniques proposed herein may utilize a UE to report PDB requirement with the designed signaling to the gNB. Once the gNB receives the PDB requirement, it may calculate the TB Size for the Tx considered the PDB. The flexible scheduling proposed herein may be conducted by considering the new defined adjustment factor S according to required PDB. In general, the TB Size factor S may be adjusted in an effort to obtain a tradeoff btw reliability, PDB and occupied resource.

The techniques proposed herein, for flexible scheduling considering PDB, can be extended to use in sidelink. This flexible scheduling considering PDB may be used regardless of whether a network entity allocates sidelink resources (model) or whether a sidelink determines/assigns sidelink resources (mode 2) of NR sidelink. Once the Tx terminator knows the PDB requirement of the waiting Tx traffic, it may adopt the flexible scheduling of MCS/TBSize/resource/Power as the previous proposals' description.

The techniques proposed herein may also be suited for relay-based transmission, since the relay may extend the Tx latency, which will impact the probability to meet the required PDB of traffic. So the PDB-based flexible scheduling proposed herein may also be used (extended) for relay-based scheduling scenarios.

As described herein, PDB-based flexible scheduling may be applied to XR-related traffic that often requires extremely low PDB, high reliability where retransmissions to improve reliability may not be suitable. The techniques presented herein may essentially aim to extend classical scheduling to flexible scheduling, by considering required PDB of XR traffic. The proposals presented herein may help enhance reliability for stringent PDB XR traffic flows besides classical reTx scheme.

### Example Operations of a User Equipment

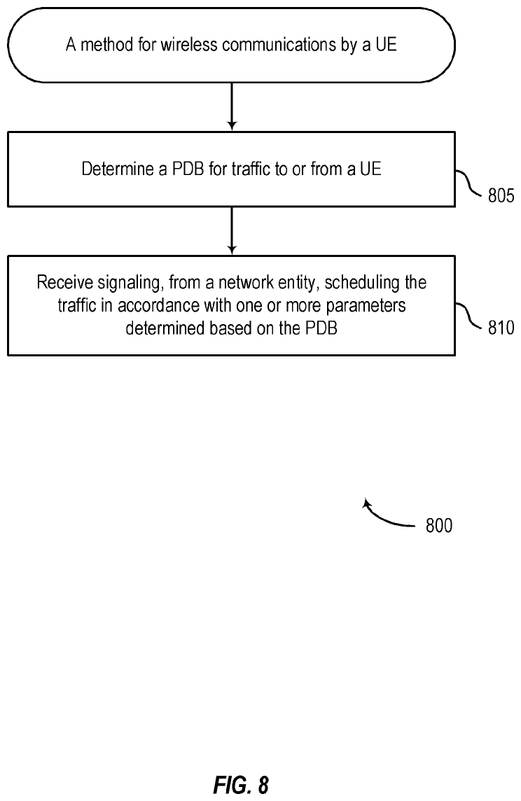

FIG. 8 shows an example of a method 800 for wireless communications by a UE, such as a UE 104 of FIGS. 1 and 3.

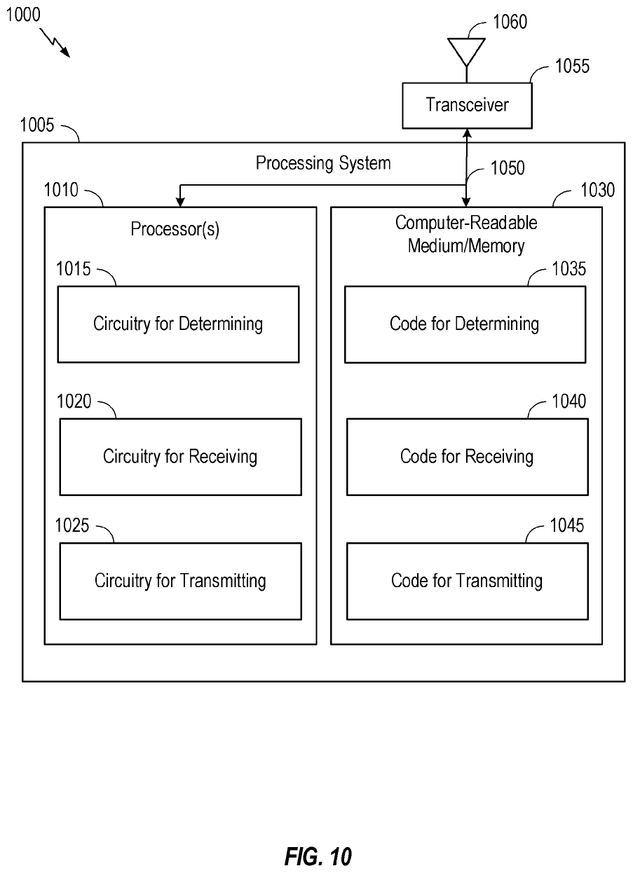

Method 800 begins at step 805 with determining a PDB for traffic to or from a UE. In some cases, the operations of this step refer to, or may be performed by, circuitry for determining and/or code for determining as described with reference to FIG. 10.

Method 800 then proceeds to step 810 with receiving signaling, from a network entity, scheduling the traffic in accordance with one or more parameters determined based on the PDB. In some cases, the operations of this step refer to, or may be performed by, circuitry for receiving and/or code for receiving as described with reference to FIG. 10.

In some aspects, determining the one or more parameters comprises: adjusting a data rate for the traffic based on a scaling factor dependent on the PDB; and adjusting one or more of the parameters based on the adjusted data rate.

In some aspects, the one or more parameters comprise at least one of a MCS, a code rate, or a TB size.

In some aspects, the scaling factor is selected from a first set of scaling factors for a first type of traffic; and the first set of scaling factors have a finer granularity than a second set of scaling factors for a second type of traffic having different PDB requirements than the first type of traffic.

In some aspects, the method 800 further includes receiving signaling, from the network entity, configuring the UE with the first and second sets of scaling factors. In some cases, the operations of this step refer to, or may be performed by, circuitry for receiving and/or code for receiving as described with reference to FIG. 10.

In some aspects, the method 800 further includes transmitting, to the network entity, an indication of the PDB for traffic to or from the UE. In some cases, the operations of this step refer to, or may be performed by, circuitry for transmitting and/or code for transmitting as described with reference to FIG. 10.

In some aspects, the indication of the PDB is transmitted via at least one of UCI or a MAC-CE.

In some aspects, the indication comprises an index into a table of parameters for the traffic.

In some aspects, the table of parameters comprise PDB and at least one of data rate or periodicity.

In some aspects, the indication of the PDB is transmitted via a BSR.

In some aspects, the indication of the PDB transmitted via the BSR comprises an index into a table of parameters for the traffic.

In some aspects, the method 800 further includes transmitting a CSI report, wherein the signaling scheduling the traffic comprises signaling scheduling CG based uplink traffic with the one or more parameters determined based on the PDB and the CSI report. In some cases, the operations of this step refer to, or may be performed by, circuitry for transmitting and/or code for transmitting as described with reference to FIG. 10.

In some aspects, the signaling scheduling the traffic comprises signaling scheduling downlink traffic and the one or more parameters comprise an expected time threshold determined based on the PDB.

In some aspects, the method 800 further includes determining that processing time of the downlink traffic exceeds the expected time threshold. In some cases, the operations of this step refer to, or may be performed by, circuitry for determining and/or code for determining as described with reference to FIG. 10.

In some aspects, the method 800 further includes transmitting UCI indicating the processing time of the downlink traffic exceeds the expected time threshold. In some cases, the operations of this step refer to, or may be performed by, circuitry for transmitting and/or code for transmitting as described with reference to FIG. 10.

In some aspects, the method 800 further includes receiving signaling indicating the expected time threshold has been adjusted based on the UCI. In some cases, the operations of this step refer to, or may be performed by, circuitry for receiving and/or code for receiving as described with reference to FIG. 10.

In some aspects, determining the one or more parameters comprises: adjusting a TBS computation factor based on the PDB.

In some aspects, the computation factor is selected from a first set of computation factor for a first type of traffic; and the first set of computation factor have a finer granularity than a second set of computation factor for a second type of traffic having different PDB requirements than the first type of traffic.

In some aspects, the signaling scheduling the traffic comprises signaling scheduling sidelink traffic.

In some aspects, the signaling scheduling the traffic comprises signaling scheduling relay-based traffic that is routed through a relay node.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Operations of a Network Entity

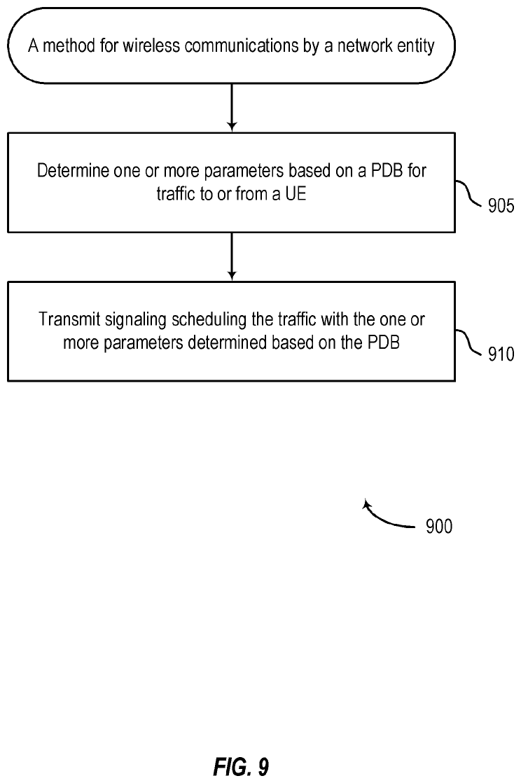

FIG. 9 shows an example of a method 900 for wireless communications by a network entity, such as a BS 102 of FIGS. 1 and 3, or a disaggregated base station as discussed with respect to FIG. 2.

Method 900 begins at step 905 with determining one or more parameters based on a PDB for traffic to or from a UE. In some cases, the operations of this step refer to, or may be performed by, circuitry for determining and/or code for determining as described with reference to FIG. 11.

Method 900 then proceeds to step 910 with transmitting signaling scheduling the traffic with the one or more parameters determined based on the PDB. In some cases, the operations of this step refer to, or may be performed by, circuitry for transmitting and/or code for transmitting as described with reference to FIG. 11.

In some aspects, determining the one or more parameters comprises: adjusting a data rate for the traffic based on a scaling factor dependent on the PDB; and adjusting one or more of the parameters based on the adjusted data rate.

In some aspects, the one or more parameters comprise at least one of a MCS, a code rate, or a TB size.

In some aspects, the scaling factor is selected from a first set of scaling factors for a first type of traffic; and the first set of scaling factors have a finer granularity than a second set of scaling factors for a second type of traffic having different PDB requirements than the first type of traffic.

In some aspects, the method 900 further includes transmitting signaling configuring the UE with the first and second sets of scaling factors. In some cases, the operations of this step refer to, or may be performed by, circuitry for transmitting and/or code for transmitting as described with reference to FIG. 11.

In some aspects, the method 900 further includes receiving an indication of the PDB for traffic to or from the UE. In some cases, the operations of this step refer to, or may be performed by, circuitry for receiving and/or code for receiving as described with reference to FIG. 11.

In some aspects, the indication of the PDB is received via at least one of UCI or a MAC-CE.

In some aspects, the indication comprises an index into a table of parameters for the traffic.

In some aspects, the table of parameters comprise PDB and at least one of data rate or periodicity.

In some aspects, the indication of the PDB is received via a BSR.

In some aspects, the indication of the PDB received via the BSR comprises an index into a table of parameters for the traffic.

In some aspects, the signaling scheduling the traffic comprises signaling scheduling CG based uplink traffic with the one or more parameters determined based on the PDB and a CSI report.

In some aspects, the signaling scheduling the traffic comprises signaling scheduling downlink traffic and the one or more parameters comprise an expected time threshold determined based on the PDB.

In some aspects, the method 900 further includes receiving UCI indicating processing time of the downlink traffic exceeds the expected time threshold. In some cases, the operations of this step refer to, or may be performed by, circuitry for receiving and/or code for receiving as described with reference to FIG. 11.

In some aspects, the method 900 further includes adjusting the expected time threshold based on the UCI. In some cases, the operations of this step refer to, or may be performed by, circuitry for adjusting and/or code for adjusting as described with reference to FIG. 11.

In some aspects, determining the one or more parameters comprises: adjusting a TBS computation factor based on the PDB.

In some aspects, the computation factor is selected from a first set of computation factor for a first type of traffic; and the first set of computation factor have a finer granularity than a second set of computation factor for a second type of traffic having different PDB requirements than the first type of traffic.

In some aspects, the signaling scheduling the traffic comprises signaling scheduling sidelink traffic.

In some aspects, the signaling scheduling the traffic comprises signaling scheduling relay-based traffic that is routed through a relay node.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Communications Devices

FIG. 10 depicts aspects of an example communications device 1000. In some aspects, communications device 1000 is a user equipment, such as a UE 104 described above with respect to FIGS. 1 and 3.

The communications device 1000 includes a processing system 1005 coupled to the transceiver 1055 (e.g., a transmitter and/or a receiver). The transceiver 1055 is configured to transmit and receive signals for the communications device 1000 via the antenna 1060, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, cause the one or more processors 1010 to perform the method 800 described with respect to FIG. 8, or any aspect related to it. Note that reference to a processor performing a function of communications device 1000 may include one or more processors 1010 performing that function of communications device 1000.

In the depicted example, computer-readable medium/memory 1030 stores code (e.g., executable instructions), such as code for determining 1035, code for receiving 1040, and code for transmitting 1045. Processing of the code for determining 1035, code for receiving 1040, and code for transmitting 1045 may cause the communications device 1000 to perform the method 800 described with respect to FIG. 8, or any aspect related to it.

The one or more processors 1010 include circuitry configured to implement (e.g., execute) the code stored in the computer-readable medium/memory 1030, including circuitry such as circuitry for determining 1015, circuitry for receiving 1020, and circuitry for transmitting 1025. Processing with circuitry for determining 1015, circuitry for receiving 1020, and circuitry for transmitting 1025 may cause the communications device 1000 to perform the method 800 described with respect to FIG. 8, or any aspect related to it.

Various components of the communications device 1000 may provide means for performing the method 800 described with respect to FIG. 8, or any aspect related to it. For example, means for transmitting, sending or outputting for transmission may include transceivers 354 and/or antenna(s) 352 of the UE 104 illustrated in FIG. 3 and/or the transceiver 1055 and the antenna 1060 of the communications device 1000 in FIG. 10. Means for receiving or obtaining may include transceivers 354 and/or antenna(s) 352 of the UE 104 illustrated in FIG. 3 and/or the transceiver 1055 and the antenna 1060 of the communications device 1000 in FIG. 10.

FIG. 11 depicts aspects of an example communications device 1100. In some aspects, communications device 1100 is a network entity, such as a BS 102 of FIGS. 1 and 3, or a disaggregated base station as discussed with respect to FIG. 2.

The communications device 1100 includes a processing system 1105 coupled to the transceiver 1165 (e.g., a transmitter and/or a receiver) and/or a network interface 1175. The transceiver 1165 is configured to transmit and receive signals for the communications device 1100 via the antenna 1170, such as the various signals as described herein. The network interface 1175 is configured to obtain and send signals for the communications device 1100 via communication link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1135 via a bus 1160. In certain aspects, the computer-readable medium/memory 1135 is configured to store instructions (e.g., computer-executable code) that when executed by the one or more processors 1110, cause the one or more processors 1110 to perform the method 900 described with respect to FIG. 9, or any aspect related to it. Note that reference to a processor of communications device 1100 performing a function may include one or more processors 1110 of communications device 1100 performing that function.

In the depicted example, the computer-readable medium/memory 1135 stores code (e.g., executable instructions), such as code for determining 1140, code for transmitting 1145, code for receiving 1150, and code for adjusting 1155. Processing of the code for determining 1140, code for transmitting 1145, code for receiving 1150, and code for adjusting 1155 may cause the communications device 1100 to perform the method 900 described with respect to FIG. 9, or any aspect related to it.

The one or more processors 1110 include circuitry configured to implement (e.g., execute) the code stored in the computer-readable medium/memory 1135, including circuitry such as circuitry for determining 1115, circuitry for transmitting 1120, circuitry for receiving 1125, and circuitry for adjusting 1130. Processing with circuitry for determining 1115, circuitry for transmitting 1120, circuitry for receiving 1125, and circuitry for adjusting 1130 may cause the communications device 1100 to perform the method 900 as described with respect to FIG. 9, or any aspect related to it.

Various components of the communications device 1100 may provide means for performing the method 900 as described with respect to FIG. 9, or any aspect related to it. Means for transmitting, sending or outputting for transmission may include transceivers 332 and/or antenna(s) 334 of the BS 102 illustrated in FIG. 3 and/or the transceiver 1165 and the antenna 1170 of the communications device 1100 in FIG. 11. Means for receiving or obtaining may include transceivers 332 and/or antenna(s) 334 of the BS 102 illustrated in FIG. 3 and/or the transceiver 1165 and the antenna 1170 of the communications device 1100 in FIG. 11.

### EXAMPLE CLAUSES

Implementation examples are described in the following numbered clauses:
Clause 1: A method for wireless communications by a UE, comprising: determining a PDB for traffic to or from a UE; and receiving signaling, from a network entity, scheduling the traffic in accordance with one or more parameters determined based on the PDB.
Clause 2: The method of Clause 1, wherein determining the one or more parameters comprises: adjusting a data rate for the traffic based on a scaling factor dependent on the PDB; and adjusting one or more of the parameters based on the adjusted data rate.
Clause 3: The method of Clause 2, wherein the one or more parameters comprise at least one of a MCS, a code rate, or a TB size.
Clause 4: The method of Clause 2, wherein: the scaling factor is selected from a first set of scaling factors for a first type of traffic; and the first set of scaling factors have a finer granularity than a second set of scaling factors for a second type of traffic having different PDB requirements than the first type of traffic.
Clause 5: The method of Clause 4, further comprising: receiving signaling, from the network entity, configuring the UE with the first and second sets of scaling factors.
Clause 6: The method of any one of Clauses 1-5, further comprising: transmitting, to the network entity, an indication of the PDB for traffic to or from the UE.
Clause 7: The method of Clause 6, wherein the indication of the PDB is transmitted via at least one of UCI or a MAC-CE.
Clause 8: The method of Clause 6, wherein the indication comprises an index into a table of parameters for the traffic.
Clause 9: The method of Clause 8, wherein the table of parameters comprise PDB and at least one of data rate or periodicity.
Clause 10: The method of Clause 6, wherein the indication of the PDB is transmitted via a BSR.
Clause 11: The method of Clause 10, wherein the indication of the PDB transmitted via the BSR comprises an index into a table of parameters for the traffic.
Clause 12: The method of any one of Clauses 1-11, further comprising: transmitting a CSI report, wherein the signaling scheduling the traffic comprises signaling scheduling CG based uplink traffic with the one or more parameters determined based on the PDB and the CSI report.
Clause 13: The method of any one of Clauses 1-12, wherein the signaling scheduling the traffic comprises signaling scheduling downlink traffic and the one or more parameters comprise an expected time threshold determined based on the PDB.
Clause 14: The method of Clause 13, further comprising: determining that processing time of the downlink traffic exceeds the expected time threshold, transmitting UCI indicating the processing time of the downlink traffic exceeds the expected time threshold, and receiving signaling indicating the expected time threshold has been adjusted based on the UCI.
Clause 15: The method of any one of Clauses 1-14, wherein determining the one or more parameters comprises: adjusting a TBS computation factor based on the PDB.
Clause 16: The method of Clause 15, wherein: the computation factor is selected from a first set of computation factor for a first type of traffic; and the first set of computation factor have a finer granularity than a second set of computation factor for a second type of traffic having different PDB requirements than the first type of traffic.
Clause 17: The method of any one of Clauses 1-16, wherein the signaling scheduling the traffic comprises signaling scheduling sidelink traffic.
Clause 18: The method of any one of Clauses 1-17, wherein the signaling scheduling the traffic comprises signaling scheduling relay-based traffic that is routed through a relay node.
Clause 19: A method for wireless communications by a network entity, comprising: determining one or more parameters based on a PDB for traffic to or from a UE; and transmitting signaling scheduling the traffic with the one or more parameters determined based on the PDB.
Clause 20: The method of Clause 19, wherein determining the one or more parameters comprises: adjusting a data rate for the traffic based on a scaling factor dependent on the PDB; and adjusting one or more of the parameters based on the adjusted data rate.
Clause 21: The method of Clause 20, wherein the one or more parameters comprise at least one of a MCS, a code rate, or a TB size.
Clause 22: The method of Clause 20, wherein: the scaling factor is selected from a first set of scaling factors for a first type of traffic; and the first set of scaling factors have a finer granularity than a second set of scaling factors for a second type of traffic having different PDB requirements than the first type of traffic.
Clause 23: The method of Clause 22, further comprising: transmitting signaling configuring the UE with the first and second sets of scaling factors.
Clause 24: The method of any one of Clauses 19-23, further comprising: receiving an indication of the PDB for traffic to or from the UE.
Clause 25: The method of Clause 24, wherein the indication of the PDB is received via at least one of UCI or a MAC-CE.
Clause 26: The method of Clause 24, wherein the indication comprises an index into a table of parameters for the traffic.
Clause 27: The method of Clause 26, wherein the table of parameters comprise PDB and at least one of data rate or periodicity.
Clause 28: The method of Clause 24, wherein the indication of the PDB is received via a BSR.
Clause 29: The method of Clause 28, wherein the indication of the PDB received via the BSR comprises an index into a table of parameters for the traffic.
Clause 30: The method of any one of Clauses 19-29, wherein the signaling scheduling the traffic comprises signaling scheduling CG based uplink traffic with the one or more parameters determined based on the PDB and a CSI report.
Clause 31: The method of any one of Clauses 19-30, wherein the signaling scheduling the traffic comprises signaling scheduling downlink traffic and the one or more parameters comprise an expected time threshold determined based on the PDB.
Clause 32: The method of Clause 31, further comprising: receiving UCI indicating processing time of the downlink traffic exceeds the expected time threshold and adjusting the expected time threshold based on the UCI.
Clause 33: The method of any one of Clauses 19-32, wherein determining the one or more parameters comprises: adjusting a TBS computation factor based on the PDB.
Clause 34: The method of Clause 33, wherein: the computation factor is selected from a first set of computation factor for a first type of traffic; and the first set of computation factor have a finer granularity than a second set of computation factor for a second type of traffic having different PDB requirements than the first type of traffic.
Clause 35: The method of any one of Clauses 19-34, wherein the signaling scheduling the traffic comprises signaling scheduling sidelink traffic.
Clause 36: The method of any one of Clauses 19-35, wherein the signaling scheduling the traffic comprises signaling scheduling relay-based traffic that is routed through a relay node.
Clause 37: An apparatus, comprising: a memory comprising executable instructions; and a processor configured to execute the executable instructions and cause the apparatus to perform a method in accordance with any one of Clauses 1-36.
Clause 38: An apparatus, comprising means for performing a method in accordance with any one of Clauses 1-36.
Clause 39: A non-transitory computer-readable medium comprising executable instructions that, when executed by a processor of an apparatus, cause the apparatus to perform a method in accordance with any one of Clauses 1-36.
Clause 40: A computer program product embodied on a computer-readable storage medium comprising code for performing a method in accordance with any one of Clauses 1-36.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a user equipment (UE), comprising:
determining a packet delay budget (PDB) for traffic to or from a user equipment (UE); and
transmitting, to a network entity, an indication of the PDB for traffic to or from the UE wherein the indication of the PDB is transmitted via at least one of uplink control information (UCI) or a medium access control (MAC) control element (CE).

2. The method of claim 1, further comprising receiving signaling, from a network entity, scheduling the traffic in accordance with one or more parameters determined based on the PDB, wherein the one or more parameters comprise a scaling factor dependent on the PDB.

3. The method of claim 2, wherein the one or more parameters comprise at least one of a modulation and coding scheme (MCS), a code rate, or a transport block (TB) size, adjusted based on the scaling factor.

4. The method of claim 2, wherein:
the scaling factor is selected from a first set of scaling factors for a first type of traffic; and
the first set of scaling factors have a finer granularity than a second set of scaling factors for a second type of traffic having different PDB requirements than the first type of traffic.

5. The method of claim 4, further comprising receiving signaling, from the network entity, configuring the UE with the first and second sets of scaling factors.

6-7. (canceled)

8. The method of claim 1, wherein the indication comprises an index into a table of parameters for the traffic.

9. The method of claim 8, wherein the table of parameters comprise PDB and at least one of data rate or periodicity.

10. The method of claim 6, wherein the indication of the PDB is transmitted via a buffer status report (BSR).

11. The method of claim 10, wherein the indication of the PDB transmitted via the BSR comprises an index into a table of parameters for the traffic.

12. The method of claim 1, further comprising:
transmitting a channel state information (CSI) report, wherein the signaling scheduling the traffic comprises signaling scheduling configured grant (CG) based uplink traffic with the one or more parameters determined based on the PDB and the CSI report.

13. The method of claim 1, further comprising receiving signaling, from a network entity, scheduling the traffic in accordance with one or more parameters determined based on the PDB, wherein the signaling scheduling the traffic comprises signaling scheduling downlink traffic and the one or more parameters comprise an expected time threshold determined based on the PDB.

14. The method of claim 13, further comprising:
determining that processing time of the downlink traffic exceeds the expected time threshold;
transmitting uplink control information (UCI) indicating the processing time of the downlink traffic exceeds the expected time threshold; and
receiving signaling indicating the expected time threshold has been adjusted based on the UCI.

15. The method of claim 1, further comprising receiving signaling, from a network entity, scheduling the traffic in accordance with one or more parameters determined based on the PDB, wherein the one or more parameters are determined by:
adjusting a transport block size (TBS) computation factor based on the PDB.

16. The method of claim 15, wherein:
the computation factor is selected from a first set of computation factor for a first type of traffic; and
the first set of computation factor have a finer granularity than a second set of computation factor for a second type of traffic having different PDB requirements than the first type of traffic.

17. The method of claim 1, further comprising receiving signaling, from a network entity, scheduling the traffic in accordance with one or more parameters determined based on the PDB, wherein the signaling scheduling the traffic comprises signaling scheduling sidelink traffic.

18. The method of claim 1, further comprising receiving signaling, from a network entity, scheduling the traffic in accordance with one or more parameters determined based on the PDB, wherein the signaling scheduling the traffic comprises signaling scheduling relay-based traffic that is routed through a relay node.

19. A method for wireless communications by a network entity, comprising:
receiving an indication of a packet delay budget (PDB) for traffic to or from a user equipment (UE); and
determining one or more parameters based on the PDB for traffic to or from the UE.

20. The method of claim 19, wherein determining the one or more parameters comprises:
adjusting a data rate for the traffic based on a scaling factor dependent on the PDB; and
adjusting one or more of the parameters based on the adjusted data rate.

21. The method of claim 20, wherein the one or more parameters comprise at least one of a modulation and coding scheme (MCS), a code rate, or a transport block (TB) size.

22. The method of claim 20, wherein:
the scaling factor is selected from a first set of scaling factors for a first type of traffic; and
the first set of scaling factors have a finer granularity than a second set of scaling factors for a second type of traffic having different PDB requirements than the first type of traffic.

23. The method of claim 22, further comprising transmitting signaling configuring the UE with the first and second sets of scaling factors.

24. The method of claim 19, further comprising transmitting signaling scheduling the traffic with the one or more parameters determined based on the PDB.

25. The method of claim 19, wherein the indication of the PDB is received via at least one of uplink control information (UCI) or a medium access control (MAC) control element (CE).

26. The method of claim 19, wherein the indication comprises an index into a table of parameters for the traffic.

27. The method of claim 26, wherein the table of parameters comprise PDB and at least one of data rate or periodicity.

28. The method of claim 19, wherein the indication of the PDB is received via a buffer status report (BSR).

29. An apparatus for wireless communication at a user equipment (UE), comprising:
a memory comprising computer-executable instructions; and
a processor configured to execute the computer-executable instructions and cause the apparatus to:
determine a packet delay budget (PDB) for traffic to or from a user equipment (UE); and
transmit, to a network entity, an indication of the PDB for traffic to or from the UE wherein the indication of the PDB is transmitted via at least one of uplink control information (UCI) or a medium access control (MAC) control element (CE).

30. An apparatus for wireless communication at a network entity, comprising:
a memory comprising computer-executable instructions; and
a processor configured to execute the computer-executable instructions and cause the apparatus to:
receive an indication of a packet delay budget (PDB) for traffic to or from a user equipment (UE); and
determine one or more parameters based on the PDB for traffic to or from the UE.
